(19) United States
(12) Patent Application Publication
(10) Pub. No.: US 2007/0026186 A1
(43) Pub. Date: Feb. 1, 2007

(54) Laminated fabric panels and method of assembling same

(75) Inventor: Serge Chapuis, Lepin Le Lac (FR)

Correspondence Address: GREENBLUM & BERNSTEIN, P.L.C., 1950 ROLAND CLARKE PLACE, RESTON, VA, 20191, US

(73) Assignee: SALOMON S.A., Metz-Tessy (FR)

(21) Appl. No.: 11/492,077

(22) Filed: Jul. 25, 2006

(30) Foreign Application Priority Data
Jul. 26, 2005 (FR) 05.08010

(51) Int. Cl. B32B 3/00

(52) U.S. Cl. 428/57; 428/102

(57) ABSTRACT

A laminated fabric panel and a method of manufacturing such panel. Each fabric panel includes at least one fabric layer and at least one water-resistant protective layer fixed to the fabric layer. The method includes assembling the two laminated panels along a predetermined joining line; flattening the two panels; pre-positioning the panels on the joining line, by means of gluing, a sealing strip provided with an adhesive; subjecting the joining line to a temperature greater than that of the adhesive melting temperature, under a predetermined pressure for a predetermined length of time, so that at least a portion of the adhesive creeps in the interstices of the fabric fibers; and subjecting the joining line, at the end of the duration time, to an accelerated cooling by cold pressing, so as to congeal the adhesive.

### CROSS-REFERENCE TO RELATED APPLICATION

This application claims priority under 35 U.S.C. §119 of French Patent Application No. 05.08010, filed on Jul. 26, 2005, the disclosure of which is hereby incorporated by reference thereto in its entirety.

### BACKGROUND OF THE INVENTION

1. Field of the Invention

The invention relates to a method of assembling laminated fabric panels and to the products thus manufactured.

More particularly, the invention relates to the field of clothing or garments and/or bags.

In further particularity, the invention relates to the field of sports garments, sports bags and/or waterproof and/or water-resistant garments.

2. Description of Background and Relevant Information

It is well known in the garment industry to use materials having a waterproof coating or laminates in order to produce waterproof garments.

The coating can be either external (for example, an oilskin coating), or the coating can be applied to the inner surface of the garment; which can generally be a PU or PVC coating.

Laminates are composite materials uniting several layers adhered together, one of them being generally made of a waterproof and/or breathable-waterproof and/or windproof membrane. These membranes can be made of PTFE, PU, etc.

Typical examples of such laminates are those provided with a so-called “breathable-waterproof” membrane, which is waterproof, but which is permeable to water vapor, such as products sold under the tradename Gore-Tex® or Sympatex®. These laminates can be made of two or three layers, depending on whether the laminate must be integrated into the garment with other layers, or used as is, as in the case of a three-layered laminate, usually referred to as the “three-ply,” the membrane being inserted between an inner liner fabric and an outer shell fabric.

In the context of this description, the expression “laminated material” will refer to both (interiorly or exteriorly) coated fabrics and laminated fabric materials provided with a film or membrane acting as a windproof, waterproof, or water-resistant (or the like) barrier. Any membrane or coating, which acts at least as a barrier to water or any other liquid penetration, will also be referred to as a “protection layer,” a “functional layer,” “membrane,” “treatment,” or “coating”.

Garments are generally made of pieces or panels of these laminates, the latter being assembled by means of stitched seams.

For garments which must be waterproof when finished, the seams must then be made waterproof, generally by applying a sealing strip provided with a thermofusible adhesive.

For practical and aesthetic reasons, the seams are generally sealed inside the garment.

Gluing the sealing strips can however pose problems, depending particularly upon the material constituting the first layer of the laminate (or liner layer), even more so for three-layered laminates, such as previously mentioned.

Thus, the document US 2005/0081281 explains that, depending upon the type of liner layer, gluing can be insufficient for properly waterproofing the seam, and that, in order to overcome this problem, the liners are generally made as simple jerseys having a mono-filament type of open structure, which reduces the choice of materials that are available for such liners. Low-viscosity or liquid glues have also been developed to overcome this problem and enable the glues to penetrate inside more complex structures (see, e.g., the documents U.S. Pat. No. 6,387,994 and WO 01/26495).

The problem with gluing also arises in relation to water repellent and/or stain repellent materials, which is especially the case with materials having a coating as known by the tradenames Scotchguard®, or Teflon®, for example, i.e., a coating based on fluorine, Teflon, or the like. Repellent treatments of this type are also called durable water repellents or “DWR”. Subsequently, the expression “repellent treatment” will refer to any water repellent and/or stain repellent and/or DWR treatment.

To overcome these problems, the aforementioned document US 2005/0022920 proposes removing or making even (by planing, grinding down, abrasion, cutting etc.) a portion of the liner fabric over at least a portion of the stitching zone to be made waterproof, the sealing strip being then applied over this entire zone.

It can be very complicated and difficult to carry out such a sizing or even-planing operation, as one must indeed not damage the membrane located beneath the evened up layer. Furthermore, it is necessary to remove enough fabric to achieve the desired goal. In addition, the thickness of the fabric layers can vary more or less substantially, especially in the case of a fleece type of material; it can therefore be very difficult and complicated to adjust the sizing machine.

### SUMMARY OF THE INVENTION

The invention overcomes the aforementioned drawbacks and proposes a new concept for assembling and waterproofing seams, especially in a garment or a bag.

The invention further proposes a concept for assembling fabric materials allowing new aesthetics.

The method according to the invention provides for the assembly of fabric panels which include the following:
providing at least two laminated panels, each laminated panel having at least one water-resistant protective layer fixed to the fabric material;
assembling the two panels along a predetermined joining line;
flattening the two laminated panels;
pre-positioning on the joining line, by means of gluing, a sealing strip provided with an adhesive;
subjecting the joining line to a temperature greater than that of the adhesive melting temperature, under a predetermined pressure, for a predetermined duration, so that at least a portion of the adhesive creeps between the interstices of the fabric fibers;
subjecting the joining line, at the end of the duration, to an accelerated cooling by cold pressing, so as to congeal the adhesive.

Such method ensures that the adhesive completely creeps into the interstices between the fabric fibers, and thus wets the fibers, even though it has been treated, therefore guaranteeing the desired waterproofness, as well as guarantees, by means of accelerated cooling, that the adhesive does not shrink or separate, thus ensuring waterproofness.

### BRIEF DESCRIPTION OF THE DRAWINGS

The invention will be better understood and other characteristics will become apparent from the following description, with reference to the attached drawings, and in which:

FIG. 1 is a schematic view of a first phase of a method according to the invention;

FIG. 2 is a schematic view of a second phase of a method according to the invention;

FIG. 3 is a schematic view of a third phase of a method according to the invention;

FIG. 4 is a schematic view of the first step in applying the sealing strip;

FIG. 5 is a schematic view of the sealing strip's adhesive material creeping step;

FIG. 6 is a schematic view of the adhesive strip cooling step; and

FIG. 7 is a view of a garment assembled according to a method of the invention.

### DETAILED DESCRIPTION OF THE INVENTION

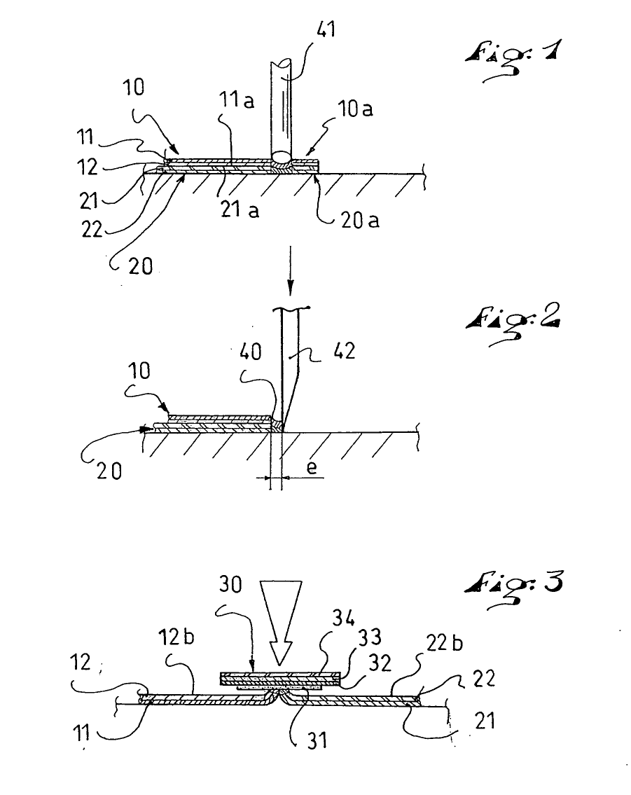

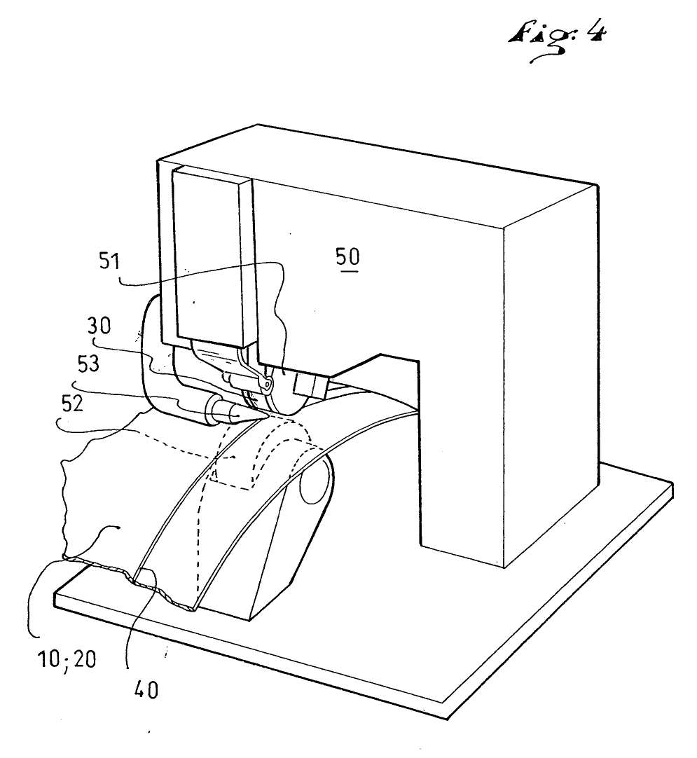

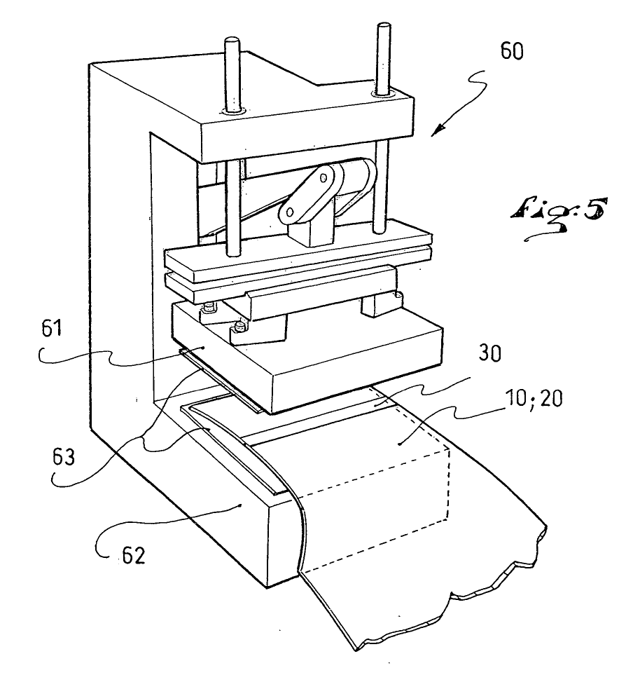

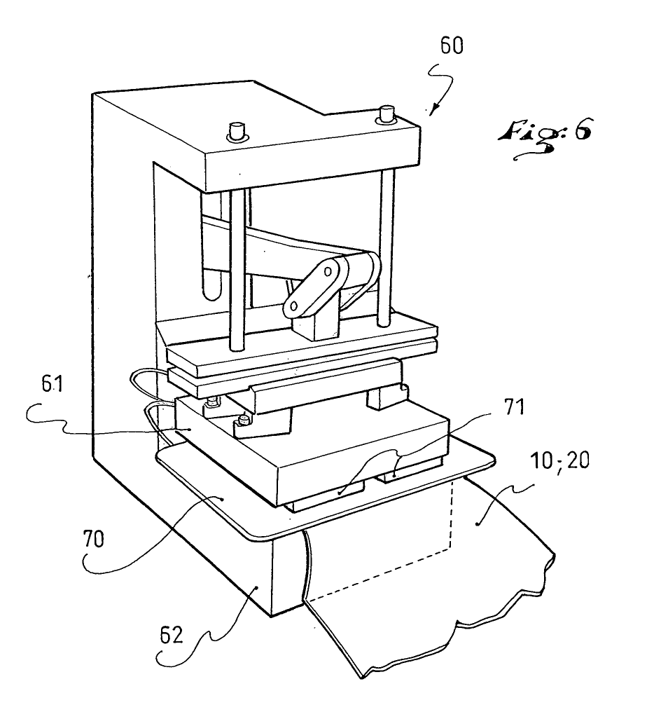

FIGS. 1 to 6 show various phases of a method according to the invention for assembling two laminated panels 10, 20.

Each laminated panel 10, 20 is made of at least two layers, 11, 12; 21, 22, respectively.

According to a first example, the laminated panels 10, 20, are water-repellent treated fabric panels (DWR), that is, they are covered with a fluorine-base coating, a Teflon-base coating, or the like, each layer 11, 21, is therefore a fabric layer, either woven, or jersey, made from a synthetic material such as PA, PE, polypropylene, with or without elastic fibers such as known by the tradename Lycra®, etc.

It can also be a fabric provided with a breathable-waterproof membrane (PTFE, PU) known as “three ply,” three layers, hereabove described.

Each layer 12, 22 shows the water repellent treatment which, for example, can be of the type known by one of the tradenames Scotchguard®, Teflon®, or the like.

Other water repellent and/or water-resistant treatments can also be provided. In the case described, the DWR treatment is applied over the outer surface of the fabric. It could also be applied over the inner surface.

In a first part of the assembly method according to the invention, the two panels 10, 20 are superimposed so that their inner surfaces 11a, 21a, face one another, that is, they are in contact with one another.

The two panels 10, 20 are then welded to one another by means of an ultrasonic welding machine (not shown in the drawing), by means of a welding tool 41 along a joining line 40.

Ultrasonic welding machines are well known, for example from the disclosure of U.S. Pat. No. 3,817,802. The machine used, therefore, has not be described in detail here.

The principle of ultrasonic welding involves vibrations at a frequency ranging from 20 to 30 KHz being applied to the welding tool. The vibrations heat up the two layers of material in contact with one another and causes them to weld to one another.

Other methods of welding are encompassed by the invention, such as, in particular, hot welding and high frequency welding.

A more conventional type of assembly, by stitching for example, is also encompassed by the invention.

The excess material 10a, 20a located on the other side of the joining line 40 is removed, almost simultaneously with the welding operation, by means of a tool 42 in the form of an suitable knife, so that only the weld or joining line 40 is left visible on the edge of the panels 10, 20.

The weld or joining line 40 then has a maximal thickness e of about 1 millimeter (mm). This principle of removing the excess material 10a, 20a can also be applied to the other methods of assembly, for example stitching, which are encompassed by the invention.

After cooling by air, or the like, for a period of about ten seconds, the two panels 10, 20, which are welded together, are laid flat so that their outer surfaces 11b, 22b, respectively, are turned upward. A sealing and reinforcement strip 30 is then applied by gluing on the visible portion of the joining line 40.

In the example shown, the sealing strip 30 is made of 4 layers, namely:
a first layer 31 of sealing glue such as sold under the tradename Ardmel TO41. This glue is extremely fluid and heat meltable so as to fill the interstices completely between the fibers constituting the fabrics 11, 21 and to ensure waterproofness. This glue is “sticky” to the touch when cold;
a second layer 32 of heat meltable polymer material having great mechanical strength and especially a great tensile strength, as well as a great resistance to washes and hydrolysis;
a third layer 33, which is a coating layer or a PU membrane with a PE polyamide basis, or the like, and which is adapted to prevent the layer 32, that is, the layer of glue, from creeping outward creeping, that is toward the fourth layer;
a fourth layer 34, which is a layer of fabric material, or the like, adapted to provide a longitudinal and transverse mechanical strength and a decorative effect. This fourth layer can be coated with a color or raised imprint to provide a decorative effect.

The two layers of glue 31, 32 can be combined into a single layer.

According to an embodiment of the invention, the layer 34 is made of the same laminated material as that of the panels 10, 20. In this case, it is also provided with the same treatment or outer coating. If the base layer 11, 21 is a laminate, that is, a complex having a breathable-waterproof membrane or the like, only the outer layer of this laminate, that is, the one without a membrane, but with or without a water repellent treatment, will be used to form the fourth layer 34 so as to limit the thicknesses.

This layer 34 can be in the same color, or in a different color so as to be in contrast with that or those of the panels 10, 20.

In the example described, the third layer 33 is used to prevent the glue from creeping toward the outer decorative layer 34 during the various steps of the method. The invention encompasses having a sealing strip with only the two first layers 31, 32, and therefore lacking a decorative layer. In this case, the third layer is not necessary, but the layer of glue 32 is provided with a mesh, or the like, embedded therein, which gives it the necessary mechanical strength and finish.

The sealing strip 30 is glued according to three separate phases shown in FIGS. 4 to 6.

In a first phase, shown in FIG. 4, the strip 30 is applied by means of a press 50 or machine for applying sealing strips such as the known type sold under the tradenames Pfaff® or Ardmel®, provided with rollers 51, 52 driving the assembled sealing strip 30 and laminated panels 10, 20, the adhesive material of the strip 30 being softened beforehand by hot air coming from a nozzle 53.

The temperature of the hot air blown from the nozzle is 130° C. or approximately 130° C., and the assembly pressure is 5 bars or approximately 5 bars.

Such an operation allows an assembly of the strip 30 that is satisfactory for holding the strip and the joining line 40, even if the assembly is done by welding, but that is insufficient to ensure waterproofness of said assembly, and therefore of the garment and/or bag in its entirety.

The actual waterproof assembly is carried out by means of the two following phases.

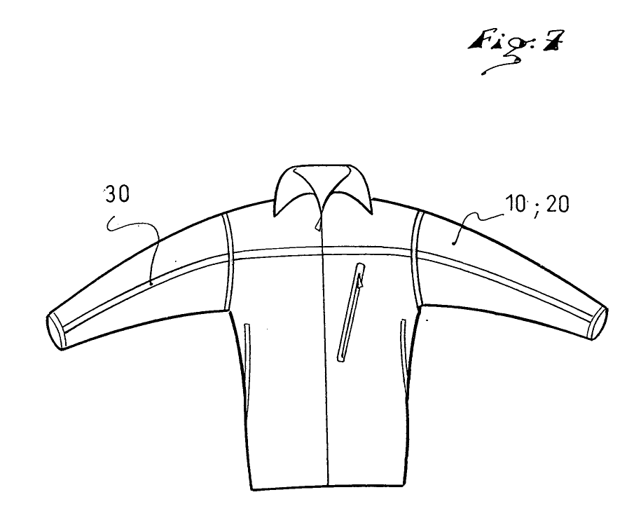

In the phase step, shown in FIG. 6, the two assembled panels provided with a sealing strip 30 are hot-pressed between the two flat beds 61, 62 of a press. The upper flat bed 61 is heating and brought to a temperature ranging between 130° C. and 150° C., or approximately within that range, which depends on the type of polymer constituting the first layer 31 of the sealing strip, and on the type of fabrics to be assembled. Sheets of silicone-coated paper 63 can be superimposed between each heating flat bed and the panels 10, 20 to prevent the glue from creeping onto these flat beds. According to the embodiment described, this temperature is on the order of 150° C., the pressure is 2 bars, and the duration of the application is approximately 25 seconds. This hot-pressing step ensures a proper creeping of the layer 31 until penetration in all of the interstices between the fibers.

At the end of this hot-pressing step, the upper flat bed 61 is raised, and lowered again after the insertion of a cold metal plate 70 provided with insulating blocks 71 to prevent any transmission of heat from the upper flat bed to the cold plate.

This cold plate 70 can simply be at room-temperature or can be cooled off to a temperature ranging from 0 to 10° C., depending on the type of glue.

The cold plate 70 is kept under a 2-bar pressure for 5 to 10 seconds. The press can also be one that includes two pivoting flat beds for hot-pressing or cold-pressing. During this last phase, a cold-pressing is undertaken, which prevents any shrinking of the first gluing layer 31 and thus ensures an adequate distribution of the glue inside interstices of the fabric and, therefore, waterproofness.

This phase is therefore particularly important for the waterproofness of the final assembly.

The assembly and waterproofing method described-hereinabove makes it possible to obtain an assembly that is waterproof at 2 m (200 mm) or 200 mbar with a rise in pressure of 60 mb/mm according to the method of dynamic testing of the ISO 811 standard and according to the method of dynamic testing of the AATCC 127 standard.

The invention is not limited to the particular several embodiments described hereinabove, but also applies to bags made from supple materials and waterproof and/or water resistant fabrics, whether they are laminated as those described, or not laminated.

The invention also applies to any type of assembly of products made from fabric materials having a waterproof and/or water resistant coating.

Further, the invention also applies to the assembly of extensible laminated panels; in this case, the sealing strip 30 has an elongation ratio that is less than that of the joining line 40, especially when the latter is made by welding.

1. A method of assembling two panels, said method comprising:
providing at least two laminated panels, each laminated panel comprising at least one layer of fabric material and one water-resistant protective layer fixed to the fabric material;
assembling the two laminated panels at a predetermined joining line;
flattening the two laminated panels;
pre-positioning on the joining line, by gluing, a sealing strip provided with an adhesive;
subjecting the joining line to a temperature greater than a melting temperature of the adhesive, under a predetermined pressure for a predetermined duration so that at least a portion of the adhesive creeps into interstices of fibers of the fabric material;
subjecting the joining line, at the end of the duration, to an accelerated cooling by cold pressing, so as to congeal the adhesive.

2. A textile article comprising:
at least two laminated panels, each laminated panel comprising at least one layer of fabric material and at least one water-resistant protective layer fixed to the fabric material, the two panels being assembled along a predetermined joining line, the joining line being covered with a sealing strip provided with a thermofusible adhesive, the adhesive having crept, at least partially, into interstices within fibers of the fabric material.

3. A textile article according to claim 2, wherein:
the two panels are assembled by having been welded together.

4. A textile article according to claim 2, wherein:
the two panels are assembled by having been stitched together.

5. A textile article according to claim 3, wherein:
an excess of material beyond the joining line is cut before the sealing strip is added.

6. A textile article according to claim 2, wherein:
the heat meltable adhesive comprises:
a first layer of a thermofusible polymer impregnating interstices between fibers of the fabric in the outer layer of the joining line; and
a second layer of a thermofusible polymer having mechanical strength characteristics.

7. A textile article according to claim 6, wherein:
the second layer of thermofusible polymer has characteristics of tensile strength and resistance to washes and hydrolysis.

8. A textile article according to claim 6, wherein:
the second layer of polymer is made of PU.

9. A textile article according to claim 6, wherein:
the sealing strip also comprises a layer of fabric.

10. A textile article according to claim 9, wherein:
the sealing strip comprises a coating layer or membrane inserted between the adhesive layer and the layer of fabric.

11. A textile article according to claim 10, wherein:
the layer of fabric is the same as a layer constituting at least an outer surface of each of the laminates.

12. A textile article according to claim 2, wherein:
the sealing strip is applied to the outer surface of the two laminated panels.

13. A textile article according to claim 2, wherein:
the sealing strip is applied to the inner surface of the laminated panels.
